(19) United States
(12) Patent Application Publication
(10) Pub. No.: US 2004/0194866 A1
(43) Pub. Date: Oct. 7, 2004

(54) Stained glass - the fusing way

(76) Inventor: Monique Feldman, Burlington, MA (US)

Correspondence Address: Monique Feldman, 21 Cedar Street, Burlington, MA, 01803, US

(21) Appl. No.: 10/302,979

(22) Filed: Apr. 1, 2003

(51) Int. Cl. B44F 1/06; B44C 5/08; C03B 23/203; B32B 17/00; C03C 27/12

(52) U.S. Cl. 156/63; 156/89.11; 156/100; 428/38

(57) ABSTRACT

A newly designed “Stained Glass” window-panel process constructed from one piece of glass without the led/zinc or copper foil assembly method. “Stained Glass—The Fusing Way” is created by utilizing a kiln firing method. The results obtained can be compared to “Stained Glass” window-panels but the “Stained Glass—The Fusing Way” delivers superior strength, maintenance free results and a safer and stronger window-panel.

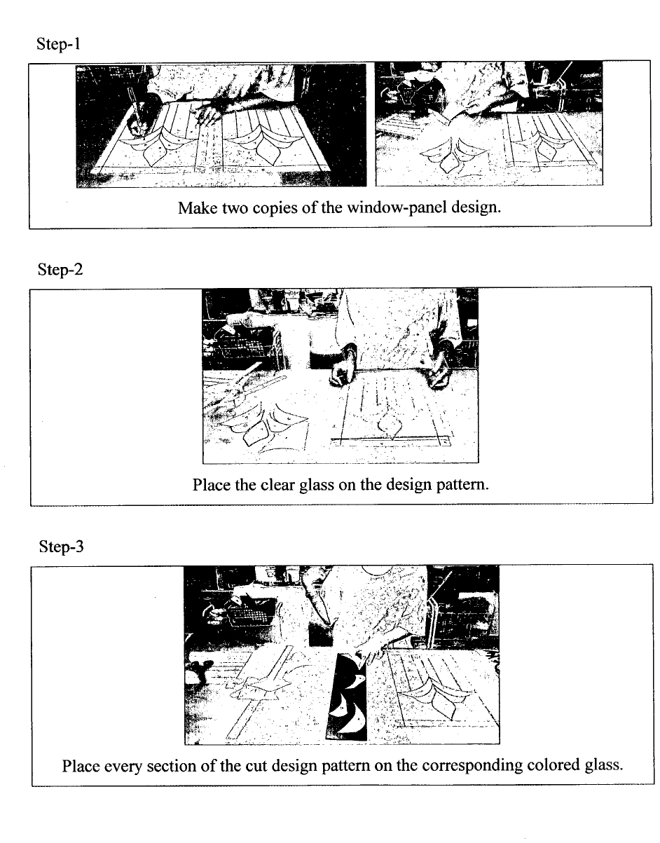

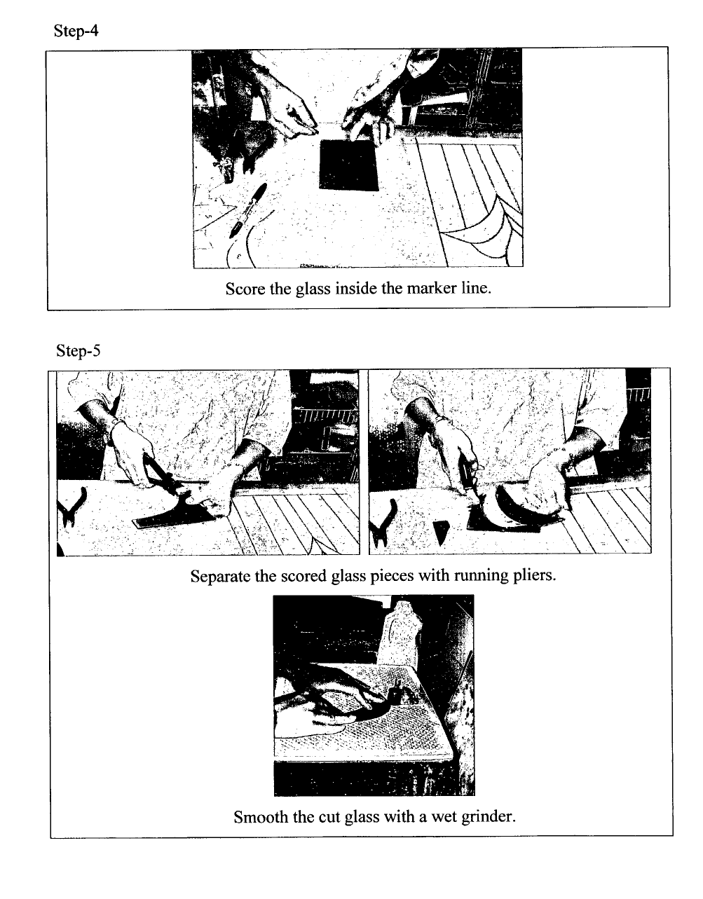

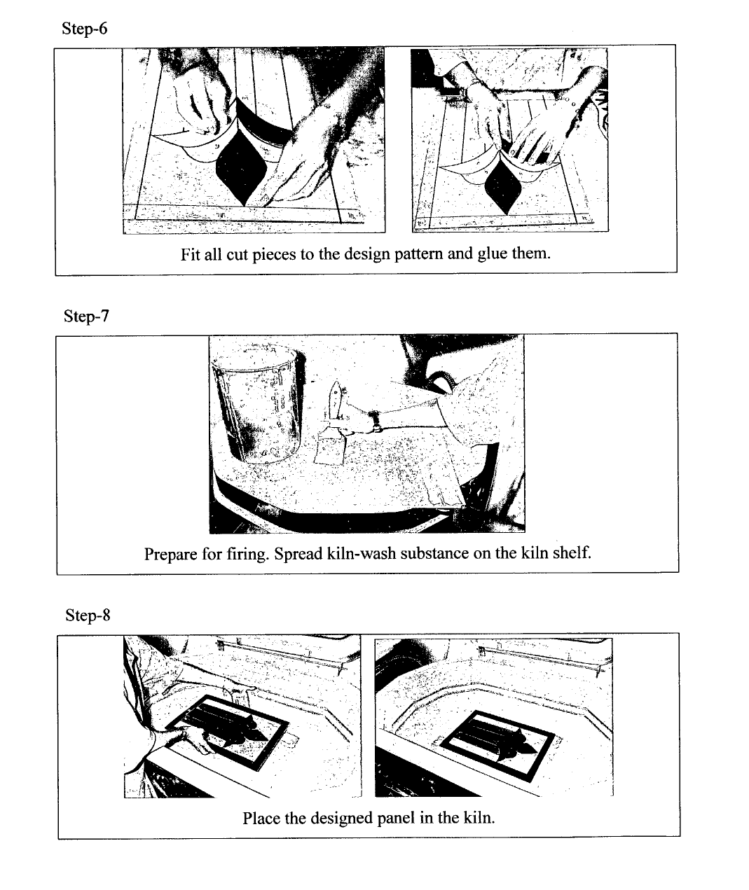

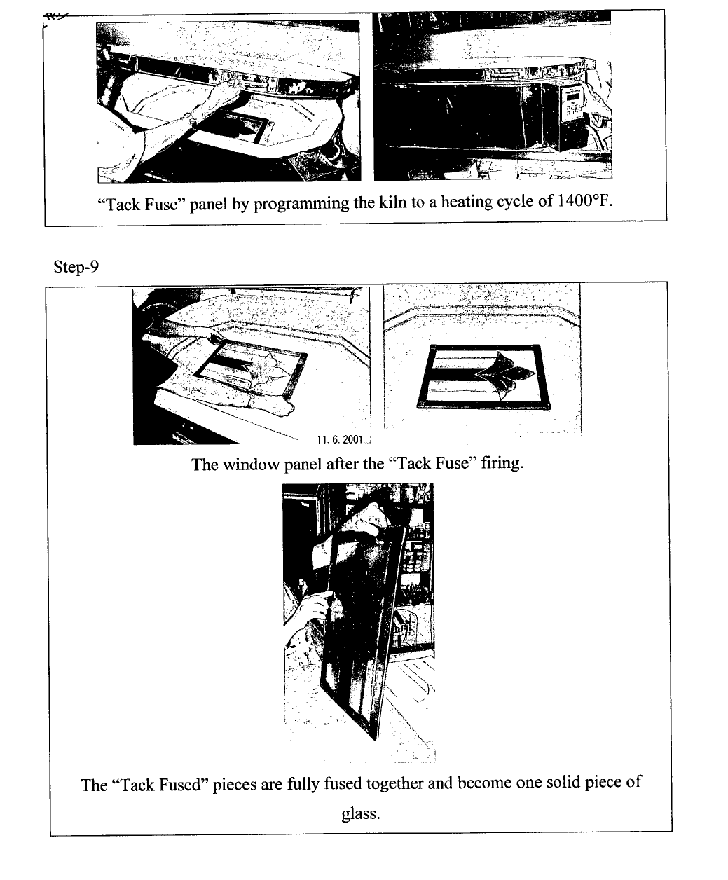

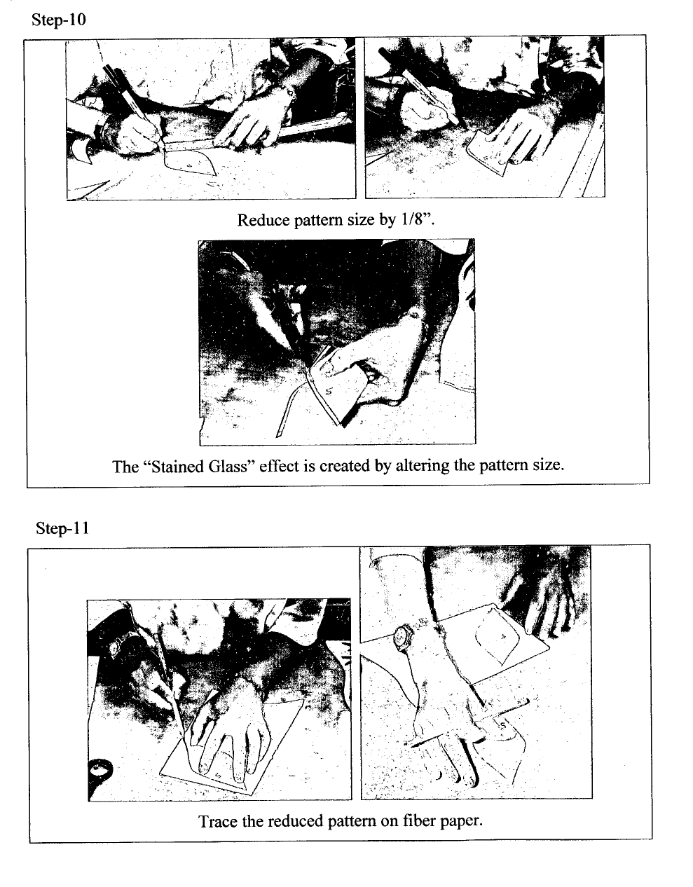

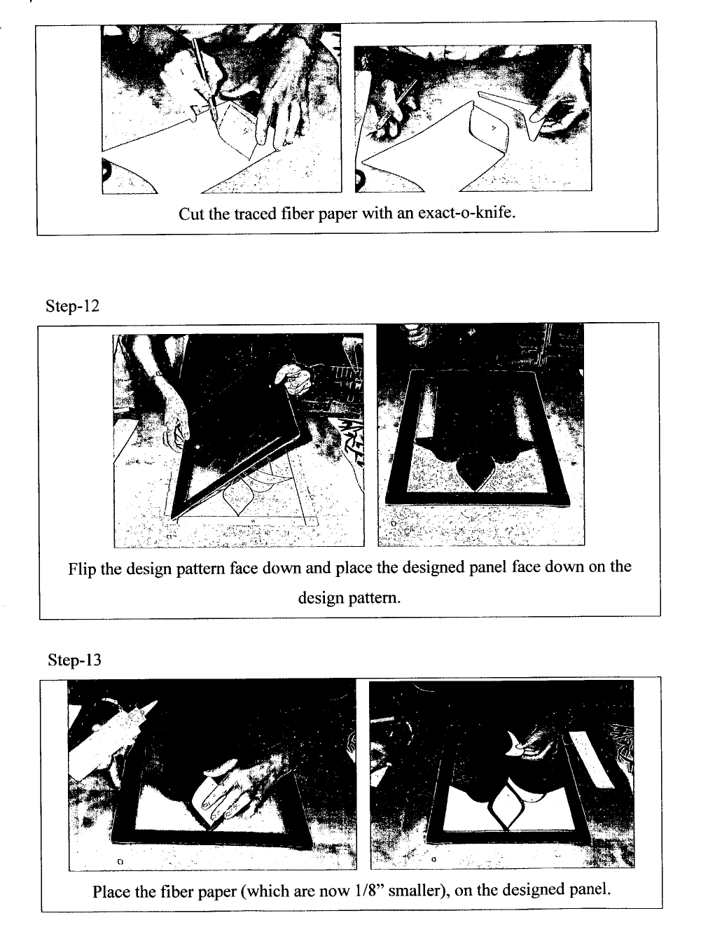

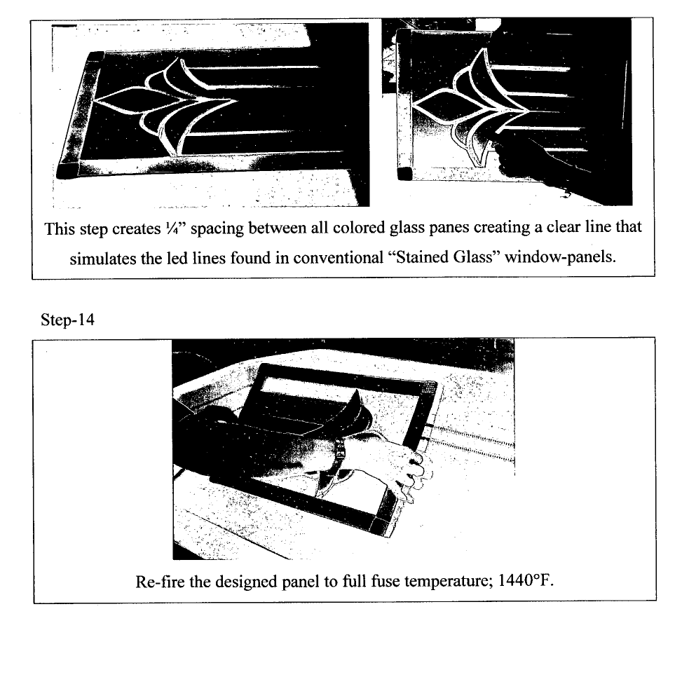

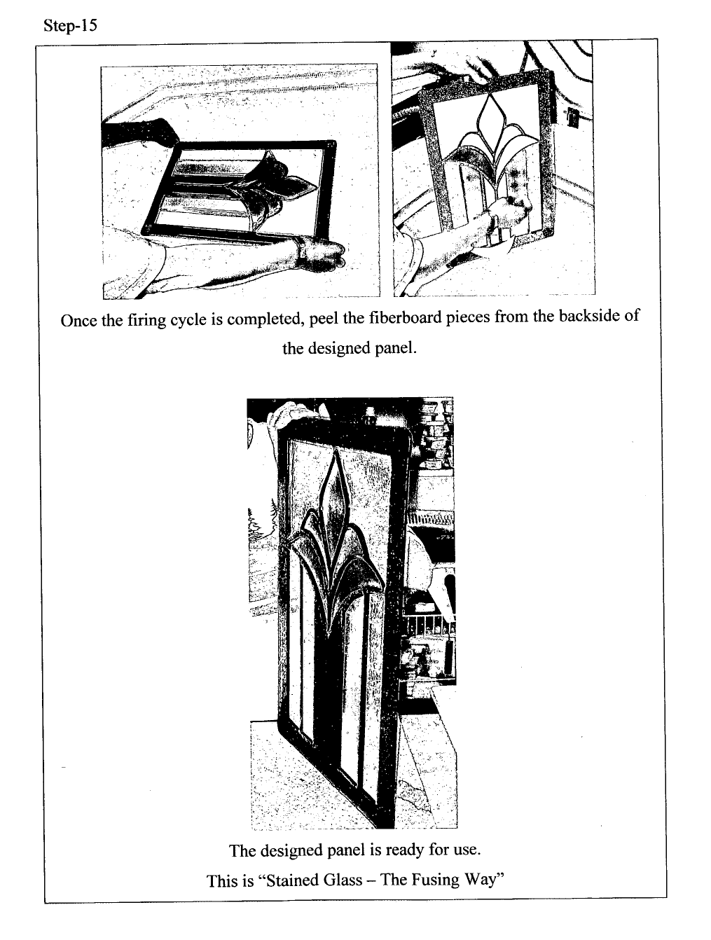

### B. CROSS REFERENCE TO RELATED APPLICATIONS

Not Applicable

### C. STATEMENT REGARDING FEDERALLY SPONSORED RESEARCH OR DEVELOPMENT

Not Applicable

### D. REFERENCE TO MICROFICHE APPENDIX

Not Applicable

### E. BACKGROUND OF INVENTION

This invention pertains to the field of art and “Stained Glass”. It applies a fused kiln formed methodology created from one piece of glass without the led/zinc or copper foil assembled method, still delivering the appearance of a conventional “Stained Glass” window-panel.

“Stained Glass—The Fusing Way” solves common conventional “Stained Glass” process problems, including but not limited to:

1. the dangerous, environmentally-destructive, cumbersome and unwielding led/zinc or copper foil assembled method;

2. the visual distortion due to reinforcing bars that are installed across the window-panel obstructing the view of the “Stained Glass” window-panel;

3. the creation of undue stress which leads to glass fracturing;

4. the inability to retain the original design and size of the glass pattern;

5. the inability to accommodate the various viscosity levels found in different glass types and different glass colors;

6. the frequent breakage, separation, melting, or deforming of the glass and its pattern/characteristics;

7. the significant blockage, reduction and adverse distortion of natural or other light;

8. the necessity of having multiple pieces of glass to achieve the desired results, light filtration, color combination, picture representation;

### F. BRIEF SUMMARY OF INVENTION

“Stained Glass—The Fusing Way” solves common conventional “Stained Glass” process problems, including but not limited to the following:

1. Durability—The designed window-panel is fused in a kiln to become one sheet of glass in comparison with a “Stained Glass” panel, which is composed of multiple pieces assembled together through a mechanical process. The fused glass panel formed in a kiln is stronger and more stable and has higher durability to temperature fluctuations. Usually in “Stained Glass” individual pieces tend to fall off or crack due to changes in temperature or stress created by structural movement. The fused glass panel remains intact unaffected by outside stress.

2. Safety—The “Stained Glass” pieces are usually assembled using led or brass, which by its nature is not healthy. The fused glass panel does not require any poisonous chemicals for its assembly.

3. Structural Integrity—“Stained Glass—The Fusing Way” window-panels are installed and handled like any glass window with no special supporting structures. In addition “Stained Glass—The Fusing Way” panels can be tempered according to building code to be used in applications such as shower doors, entry doors and partition walls. In comparison “Stained Glass” window-panels are for decorative purposes only and require structural support, which becomes increasingly complex based on the location of the “Stained Glass” window-panel and its physical size.

4. Strength—“Stained Glass—The Fusing Way” enables the glass pieces to remain strong, connected, whole (not melted), accurate (not deformed), and appropriately saturated to accommodate the various viscosity levels found in different glass types and colors by using a “tack fuse” process to bind all the cut colored glass pieces to the background glass (the “tack fuse” process is explained in Step-8. of section H. bellow).

5. Complex Maintenance—“Stained Glass” window-panels tend to curve and bend requiring reinforcing bars and on-going maintenance/re-glazing, which can be extremely complex up to the point where it may require disassembly and re-assembly of an entire window or part of it. In comparison “Stained Glass—The Fusing Way” panels do not have structural integrity problems. The maintenance of the fused glass panel is similar to the maintenance of any glass window requiring only cleaning. In addition “Stained Glass—The Fusing Way” does not require re-glazing.

6. Visual Advantages—“Stained Glass—The Fusing Way” overcomes the limitations imposed by the led lines found in conventional “Stained Glass” window-panels, which obstructs the light reflected through the panel providing less light per square inch. Since “Stained Glass—The Fusing Way” window-panels are made from glass only, the entire window-panel can reflect light increasing the overall light transmission per square inch.

7. Additional benefits not available in conventional “Stained Glass” window-panels—“Stained Glass—The Fusing Way” technique creates the illusion of depth via light rays transmitted through the clear glass lines, which become 3-dimensional during the fusing process and provides translucence from multiple angels enhancing the glass colors used in the window-panel design. “Stained Glass—The Fusing Way” window-panels provide more light reflection per square inch than conventional “Stained Glass” panels.

### G. BRIEF DESCRIPTION OF THE SEVERAL VIEWS OF THE DRAWING

Please see section K.—drawings.

### H. DETAILED DESCRIPTION OF THE INVENTION

Introduction: “Stained Glass—The Fusing Way” is created, developed and produced via the following steps.

We reserve the right to modify and further supplement this patent application as necessary. We also reserve the right to amend this patent application.

Step-1

Make two copies of your window-panel design pattern (“design pattern”) on paper. Number each section on the design pattern. One design pattern will be scissor cut on the marker line to be used for the glass cutting correspondingly. The second design pattern will be used as a layout guide for assembling the designed panel.

Step-2

Cut ⅛″ thick piece of clear glass compatible with the colored glass selected for the designed panel. The clear piece of glass has to be cut to the final dimension of your designed panel (compatibility characteristics allows multiple pieces of glass to be fused together and after proper cooling to room temperature leave no undue stresses that will lead to fracturing). Place the clear piece of glass on the design pattern. The clear piece of glass is used as the background of the designed panel, providing the physical support for the cut colored glass pieces.

Step-3

Take the sections of the cut design pattern; place every section on the corresponding colored glass and trace around the sections with a marker. The tracing will mark the colored glass shapes to be cut.

Step-4

Using a standard glasscutter, score the glass on the inside of your marker line to prevent deformation of the final dimensions of the panel. Repeat the glass scoring process for all the marked pieces of colored glass.

Step-5

Separate the glass pieces using running players or breaking players. Repeat this operation for all the colored glass pieces. Smooth the edges of the colored glass pieces with a wet grinder.

Step-6

Match the cut pieces of glass to the numbers of the sections from the design pattern as reflected through the clear glass described in Step-2. When all the cut pieces are fitted, glue them one at a time with fusing glue to the clear piece of glass to retain the original design layout and design size (Fusing glue is a binder that will fire at low temperature with no residue, while preventing the glass pieces from shifting on the background piece).

Step-7

Prepare for firing: A kiln shelf or fiber board at least ½″ bigger than your final window-panel dimension. The kiln shelf needs to be kiln washed with a few layers of kiln-wash and let dry.

Kiln Shelves are made of clay and provide the necessary elevation of the fusing surface from the bottom of the kiln to prevent the glass pieces from sticking to the kiln bottom. Kiln-wash is the suspension agent to prevent the glass from sticking to the kiln shelf Fiberboard is used as a replacement for kiln shelves when shelf size requirements exceed the standards. Fiberboard is made of refractory material (alumina silicate fiber board), which withstands the heat produced during the kiln forming process. Fiberboard can be cut and bent, allowing complex moldings design for more complex glass shapes.

The kiln wash is a separator/primer made of a mixture of hydrate alumina and china clay binders.

Step-8

Place the designed panel on top of the kiln shelf/fiber board in the kiln and “Tack Fuse” to 1400° F. degrees, soaking the heat for 20 minutes. “Tack Fuse” is fusing at the lowest temperature possible, which permits the pieces to adhere to each other while neither melting nor deforming and remaining connected for further processes. The glass retains all of its individual characteristics and their edges round slightly. The 20 minutes soaking provides even-heat saturation to the glass pieces to accommodate the various viscosity levels found in different glass types and different glass colors. “Tack Fusing” creates one sheet of glass by binding all the cut colored glass pieces to the background clear glass thereby creating the strength and durability of one glass sheet to the designed panel.

The firing sequence has the following steps: initial heat, rapid heat, heat soak, rapid cool, anneal soak, anneal cool and cool to room temperature. Each firing step is composed of the speed of heating, measured in degrees per minute and the amount of time spent at each temperature. Firing sequences may vary based on kiln and glass type. The firing sequence needs to be determined and programmed via the kiln control panel, for each designed panel prior to firing.

Step-9

The following steps (10, 11, 12, 13, 14, 15) provide the “Stained Glass” effects to the designated panel by displaying a visual separator between the colored glass panes while keeping the designated panel as one sheet of glass with all the strength characteristics found in glass panels.

Once the kiln firing sequence completed, the “Tacked Fused” pieces are fully fused together and became one solid piece of glass. The “Tack Fused” solid piece of glass can be removed from the kiln.

Step-10

Take the cut pieces of the designed pattern used to cut the glass and reduce its size by ⅛″ around. This size reduction is necessary to provide the spacing measurement between the colored glass panes in order to create the visual effect provided by the led lines in a conventional “Stained Glass” window-panel. The “Stained Glass” effect is obtained by altering the size of the design pattern without adding any other substances to the glass panel.

Step-11

After the pattern size was reduced by ⅛″, place the reduced size pattern on ⅛″ thick fiber paper, trace around the pattern with a pencil, cut the traced fiberboard with an exact-o-knife and number the cut pieces according to the numbering method described in Step-2.

The fiber paper pieces that were just cut will become the mold to be used to create the 3-dimensional visual effect normally provided by the led lines in a conventional “Stained Glass” window-panel.

Step-12

Flip the design pattern face down and place the designed panel face down on the design pattern. This step will create a reverse match between the panel and the original design pattern so you can create the led lines effect described in Step-11. The led lines visual effects will be created on the backside of the panel.

By eliminating the conventional “Stained Glass” led lines and creating the “Stained Glass” effect within the glass design, the designed panel will:

1) transmit more light than a conventional “Stained Glass” window-panel;

2) the designed panel will have a 3-dimensional effect;

3) the designed panel will be stronger than conventional “Stained Glass” window-panels;

4) the designed panel colors will be brighter than conventional “Stained Glass” window-panels, due to more light access per square inch;

5) the designed panel will look sharper since the fusion techniques provides improved accuracy over conventional “Stained Glass” cutting methods;

6) the designed panel will have more transparency per square inch since it does not need the led connection used in conventional “Stained Glass” window-panels to connect between the pieces while blocking the light;

7) the designed panel will be safer to use in kitchens, bathrooms, children rooms or any other location where led “Stained Glass” window-panels are normally not recommended for health reasons.

Step-13

Start placing your numbered fiber paper sections (which are now ⅛″ smaller), on the designed panel according to the design underneath leaving ⅛″ rim all around each piece proportionally. This step will create an overall ¼″ spacing between all colored glass panes, providing a clear line to simulate the led line found in conventional “Stained Glass” window-panels. Although the designed panel is made of one glass piece, this method will create the visual effect of multiple glass pieces. By simulating the lines via clear glass spaces, the designed glass panel will transmit more light, which differentiates it from the led lines in conventional “Stained Glass” window-panels, which blocks the light by reducing the overall light transmission from the opening. In addition, the effects are more pronounced due to light rays transmitted in multiple angles through the glass panel instead of one-dimensional transmission in a conventional “Stained Glass” window-panel.

Step-14

Re-fire the designed panel to full fuse temperature, 1440° F. for 30 minutes soaking time. Full fuse temperature will melt the glass to its liquid form causing the glass between the fiber paper spaces to melt creating a ¼″ wide and ¼″ thick clear line channel between the colored glass panes. Consequently this melting will create the led lines effects normally found in conventional “Stained Glass”.

Step-15

Once the firing cycle is completed, peel the fiberboard pieces from the backside of the designed panel, unveiling the “Stained Glass—The Fusing Way”, which simulates the led lines in a conventional “Stained Glass” window-panel.

The newly designed panel is now ready for use or it can be submitted to a tempering process if required by the building code.

1. I claim as my patent process, the process of a newly designed “Stained Glass” window-panel type arrangement comprising of an array of individual panes and having the appearance of a conventional “Stained Glass” window-panel using any pattern with a fused kiln formed methodology to create one piece of glass without the led/zinc or copper foil assembly method. The process eliminates the recurring maintenance normally required by “Stained Glass” window-panels. “Stained Glass—The Fusing Way” reduces the reinforcements usually required with conventional “Stained Glass” window-panels. “Stained Glass—The Fusing Way” created via this process is safer and it doesn't use hazardous materials such as led.
